(19) United States
(12) Patent Application Publication
(10) Pub. No.: US 2003/0024164 A1
(43) Pub. Date: Feb. 6, 2003

(54) Glass fiberizing combustion fuel mixture

(76) Inventor: Jianjun Li, Westerville, OH (US)

Correspondence Address: OWENS CORNING, 2790 COLUMBUS ROAD, GRANVILLE, OH, 43023, US

(21) Appl. No.: 10/235,455

(22) Filed: Sep. 5, 2002

Related U.S. Application Data
(62) Division of application No. 09/474,506, filed on Dec. 29, 1999, now abandoned.

(51) Int. Cl. C01B 3/32

(52) U.S. Cl. 48/127.3; 65/454

(57) ABSTRACT

A combustion fuel mixture is provided for heating a fiberizer spinner for the production of glass fiber. In a first embodiment, oxygen enriched air is added to natural gas to form the combustion fuel mixture. In a second embodiment, pure oxygen is mixed with natural gas to form the combustion fuel mixture. Combustion of the combustion fuel mixture reduces emissions, increases efficiency of glass fiber production and reduces the amount of natural gas required to heat the fiberizer.

### TECHNICAL FIELD AND INDUSTRIAL APPLICABILITY OF THE INVENTION

This invention relates to fuels. More specifically, this invention relates to a combustion fuel mixture for fiberizing molten glass.

### BACKGROUND OF THE INVENTION

Glass consists basically of a mixture of inorganic oxide materials. When formulated properly, it can exist in a molten state at high temperature with high viscosity. While in a molten state, glass can flow and be extended into elongated glass fibers. After glass fibers are formed from the molten state, they can be quickly cooled into a solid state. This process is referred to as the fiberizing process. The apparatus which converts the molten minerals or glass into fibers is known as a fiberizer.

Various applications have been found for mineral fibers, ranging from textile, composite reinforcement, to thermal and acoustical insulation, the fiberous product is commonly referred to as mineral wool, glass wool, or fiberglass. Fiberglass for thermal and acoustical applications is now widespread in residential, commercial and industrial housing constructions. The forming technique for fiberglass varies from pulling, blowing, to rotary fiberizing.

In order to convert molten glass into fiberglass, the fiberizer receives a hot molten glass stream and converts it into fibers having a desired diameter and length. To accomplish this, a fiberizer spinner is heated up by the combustion reaction of a mixture of fuel and air mixture and caused to spin as the molten glass is dropped into the spinner. The centrifugal force of the spinner drives the molten glass through holes in the side of the spinner, creating multiple glass stream primaries. These glass stream primaries are immediately attenuated downward by a high speed blower and combustion products formed from combustion of the fuel and air mixture, forming glass wool fibers.

Upon exiting the fiberizer, the fibers are cooled by a spray of water and then sprayed with a binder before they are distributed onto a forming chain. The fibers are drawn downwardly by negative pressure suction into a forming box from which the combustion gasses are exhausted.

An external burner heats up the spinner and surrounding area and an internal burner may be used to pre-heat the spinner. The external burner has a dominant effect on fiber diameter, length and subsequently fiber quality. As the pressure of the fuel and air mixture through the burner is raised, the heat from the combustion reaction of the fuel and air mixture increases and the spinner face temperature is elevated. The temperature elevation causes the glass primaries to become thinner and flow more easily. As a result, glass fiber diameter will go down and the fiber length will decrease.

Currently, the burners in the fiberizer used to heat up the spinner use a simple air and natural gas mixture input. In a typical combustion process using an air/gas fired burner, natural gas and air is usually combined in a set ratio of 10 parts air to 1 part natural gas by volume. Nitrogen constitutes 78% of air by volume and contributes nothing to the combustion process. Due to the use of air, energy generated from the combustion of air and natural gas is wasted in heating the inert nitrogen to the elevated temperatures needed to fiberize molten glass. Using an air and natural gas mixture results in an inefficient burn because of the dilution of the inert nitrogen and, as a result, large volumes of natural gas are needed to drive the combustion reaction to raise the temperature of the spinner to levels required to attenuate the molten glass. The presence of nitrogen in the air detracts from the heating process by carrying part of the heat of combustion away from the process.

The combustion of the natural gas and air mixture produces large volumes of environmentally harmful combustion by-products, primarily in the form of NOₓ emissions. While NOₓ emissions constitute the majority of the environmental pollutants produced during the combustion of natural gas and air, smaller amounts of other environmental pollutants are also produced. In order to remove the combustion by-products formed during the combustion reaction from the combustion environment, a hood operates with high levels of suction to draw and exhaust the by-products. The suction which is required to exhaust the by-products also draws down and captures the glass fibers in a forming area where the glass fibers are compressed into a fiber pack. The by-products are drawn through the glass fiber pack before being exhausted through a vented floor. The fiber pack is often over-compressed from the force of gasses being drawn through the fiber pack. Over-compression of the pack often renders at least portions of the glass fibers unuseable.

### SUMMARY OF THE INVENTION

It is therefore an objective of the present invention to provide a combustion fuel mixture which burns more efficiently to heat a fiberizer spinner for the production of glass fiber.

It is another objective of the present invention to provide a combustion fuel mixture to heat a fiberizer spinner which reduces environmental pollutants formed during the combustion reaction of the combustion fuel mixture.

It is a further objective of the present invention to provide a combustion fuel mixture which produces a more efficient combustion reaction in order to reduce the amount of natural gas required to heat a fiberizer spinner.

It is yet another objective of the present invention to provide a combustion fuel mixture for a fiberizer spinner which produces a more efficient combustion reaction to reduce the amount of energy lost to the formation of environmental pollutants, thereby, reducing the amount of suction required to exhaust by-product emissions from the combustion reaction environment out through an exhaust hood, thereby, reducing compaction of formed glass fibers.

The objectives of the present invention are achieved in a first embodiment of a combustion fuel mixture for heating a fiberizer spinner for the production of glass fiber by enriching air with oxygen to produce oxygen enriched air, and combining the oxygen enriched air with natural gas to form the combustion fuel mixture in which natural gas is combusted more efficiently, thereby producing less environmental pollutants, such as NOₓ, and requiring less suction to exhaust combustion by-products out through an exhaust hood, thereby, reducing compaction of formed glass fibers. The combustion fuel mixture is supplied to fiberizer burners in a fiberizer and for heating the fiberizer spinner and enhancing the efficiency of fiberizing molten glass into glass fibers.

In an alternative embodiment, the presence of inert nitrogen is eliminated by mixing natural gas with pure oxygen to form the combustion fuel mixture. The natural gas and pure oxygen combustion fuel mixture is provided to the fiberizer burners where the combustion reaction heats the fiberizer spinner more efficiently than the aforementioned inventive enriched air and natural gas combustion fuel mixture, thereby further improving the benefits of the oxygen enriched air and natural gas combustion fuel mixture described above as well as eliminating the production of NOₓ from the combustion reaction

The efficiency of the combustion reaction of the combustion fuel mixture of the present invention is enhanced up to about 5 times over prior art air and natural gas fuel mixtures. By substantially reducing the production of NOₓ and other environmental emissions, the improved efficiency of the combustion reaction reduces the volume of natural gas consumption by about 50% to about 80% while heating the fiberizer spinner to the desired temperature for fiberization. Also, because the combustion reaction is “hotter” with the present inventive combustion fuel mixture, the fiberizer spinner is heated to the desired temperature more rapidly.

When oxygen enriched air is mixed with natural gas to form the combustion fuel mixture, the formation of NOₓ is substantially reduced. When pure oxygen is mixed with natural gas to form the combustion fuel mixture, the formation of NOₓ is eliminated from the combustion reaction. By reducing by-product formation during the combustion reaction, less suction is needed to draw down glass fibers from the spinner into a forming box where the glass fibers are captured. Fiberglass recovery, thereby, is increased by reducing compression of the glass fibers in the forming box by reducing the amount of suction needed to draw the byproducts through the formed glass fibers.

Thus, a combustion fuel mixture is provided which enhances the efficiency of the combustion of natural gas resulting in less energy lost to heating inert nitrogen occurring naturally in air, reducing the amount of environmental pollutants, e.g., NOₓ, enhancing the recovery of fiberglass product, reducing the volume of natural gas needed to heat the fiberizer spinner, and reducing the amount of energy needed to exhaust the gaseous emissions from the combustion process, all of which resulting in a substantial cost savings in glass fiber production.

### BRIEF DESCRIPTION OF THE DRAWING

The FIGURE shows a cross-sectional view of a molten glass fiberizer to which the present inventive combustion fuel mixture is supplied.

### DETAILED DESCRIPTION AND PREFERRED EMBODIMENTS OF THE INVENTION

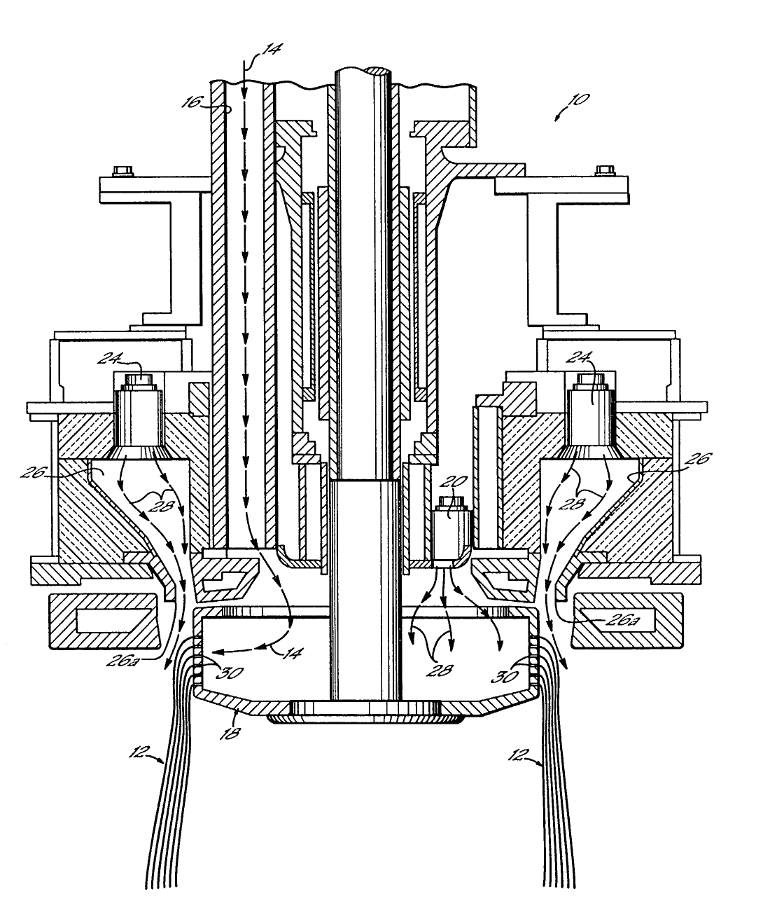

The present invention is a combustion fuel mixture supplied to a molten glass fiberizer 10 to produce glass fibers 12 for a fiberglass or mineral wool product (not shown), as seen in FIG. 1. The fiberizer 10 depicted in FIG. 1 represents one type of fiberizer in which the present inventive combustion fuel mixture may be used and use of the present inventive combustion fuel mixture is not intended to be limited to the fiberizer 10. For example, the combustion fuel mixture may also be used in the type of fiberizer described in U.S. Pat. No. 5,523,031, owned by the assignee of the present invention, the description of which being hereby incorporated in its entirety herein by reference. Another example of a fiberizer in which the present inventive combustion fuel mixture may be used is seen in U.S. Pat. No. 5,582,841, owned by the assignee of the present invention, the description of which being hereby incorporated in its entirety herein by reference.

In general, the fiberizer 10 receives molten glass 14 dropped through a delivery tube 16 into a spinner 18 which rotates at a very high rate of speed. The spinner 18 has an internal burner which preheats the spinner 18 with combustion by-products 28. The spinner 18 has a spinner face 22 which is heated up by an external burner 24. The combustion fuel mixture is consumed in burner chamber 26 by a combustion reaction, discussed more fully below. The flame produced by combustion of the combustion fuel mixture is ejected through a flame ring 26a proximate the spinner face 22. The spinner face 22 defines a plurality of holes 30 through which the molten glass 14 is ejected due to centrifugal force created by rotation of the spinner 18. As the molten glass 14 is ejected from the holes in the spinner face 22, the molten glass 14 is heated and attenuated into glass fibers 12 which are blown downward into a forming room (not shown), in part, by the by-products 28 produced from combustion of the combustion fuel mixture ejected through flame ring 26a. Because the glass fibers 12 are so light, negative pressure is created in the forming room by suction through the forming room floor to draw down the glass fibers 12 to create a fiber pack. The suction in the forming room compresses the fiber pack upon the forming room floor. The attenuated glass fibers which form the fiber pack generally comprise the raw material from which a glass fiber product such as fiberglass is produced. The combustion by-products from the combustion fuel mixture are sucked through the forming room floor and exhausted through a venting hood (not shown).

In a first embodiment of the present inventive combustion fuel mixture, oxygen is mixed with air to form oxygen enriched air. The oxygen enriched air is thereafter mixed with natural gas to from the combustion fuel mixture. At atmospheric pressure, nitrogen constitutes about 78.03% of air. Enough oxygen is added to air to produce oxygen enriched air which contains less nitrogen than naturally occurs in air at atmospheric pressure. Preferably, an amount of oxygen is added to the air to produce oxygen enriched air having from about 1% to about 74% nitrogen. That is, the relative amount of nitrogen in the oxygen enriched air is reduced by about 4% or more as compared to non-oxygen enriched air. More preferably, the oxygen enriched air is comprised of about 50% oxygen. Most preferably, the oxygen enriched air is comprised of about 70% to about 80% oxygen.

Nitrogen is considered to be an inert gas due to its non-reactive nature with many materials. However, nitrogen can react to form certain compounds under the influence of chemicals, catalysts or high temperature. By reducing the relative amount of nitrogen in the oxygen enriched air, the amount of nitrogen available to form environmental pollutants, e.g., NOₓ, is reduced, thereby, reducing the amount of NOₓ created from the combustion reaction of the combustion fuel mixture. By reducing the relative amount of nitrogen in the oxygen enriched air, the efficiency of the combustion reaction of the combustion fuel mixture will improve by virtue of reducing the relative amount of energy last to the formation of NOₓ, thereby allowing the combustion reaction to burn at higher temperatures. Also, the fiber pack will not become overcompressed on the forming room floor since less suction is required to draw out and exhaust the smaller volume of combustion by-products produced.

In a second embodiment of the present inventive combustion fuel mixture, pure oxygen is mixed with natural gas to form the combustion fuel mixture. The pure oxygen and natural gas fired burners have a more luminous flame then the flame of air and natural gas fired burners. This results in better heat transfer to the glass fibers and a reduction in the natural gas usage for the fiberizer of about one-third due to the better heat transfer and the elimination of the need to heat up the large volumes of nitrogen found in the air in air and natural gas fired burners. The pure oxygen and natural gas combustion fuel mixture basically eliminates the presence of inert nitrogen during them combustion reaction. As a result, formation of NOₓ is eliminated from the combustion of the pure oxygen and natural gas combustion fuel mixture. The improved efficiency of the combustion reaction of the combustion fuel mixture eliminates inefficient heating of inert nitrogen and, therefore, allows the combustion reaction to be completed with formation of very little combustion by-products, thereby further elevating the temperature of the combustion reaction and further reducing the amount of suction required to exhaust combustion by-products.

The reduction of combustion by-products from combustion of present combustion fuel mixtures allows suction to form the fiber pack and exhaust the combustion by-products to be reduced by about 30% to about 50%. Reduced suction results in enhanced recovery of glass fibers by reducing compression of the fiber pack in the forming room.

In forming the pure oxygen and natural gas combustion fuel mixture, it is contemplated that varying amounts of oxygen may be added to natural gas to produce a combustion reaction in which the completion of combustion of the pure oxygen and natural gas combustion fuel mixture varies. Preferably, an amount of pure oxygen should be added to natural gas to produce a combustion fuel mixture having an amount of excess oxygen ranging from about −2% to about +5% by volume. A combustion fuel mixture comprised of −2% oxygen is a fuel rich mixture in which excess natural gas is not consumed in the combustion reaction. A combustion fuel mixture which contains +5% oxygen is an oxygen rich combustion fuel mixture in which excess oxygen is not consumed during the combustion reaction. While it is preferred to have an amount of excess oxygen in the range of about −2% to about +5%, it most desirable to have about 1.5% excess oxygen. As the amount of excess oxygen in the combustion reaction is increased, lower amounts of carbon monoxide are produced during the combustion reaction.

The basic combustion reaction for natural gas in the presence of oxygen is:

CH₄+2O₂CO₂+2H₂O

In addition to formation of carbon dioxide and water by-products from the combustion reaction, minor amounts of carbon monoxide (CO), carbon (C) and hydrogen (H₂) are formed.

By reducing or substantially eliminating the amount of inert nitrogen from the combustion reaction, the combustion fuel mixture burns hotter. With a hotter burn, less natural gas is required to elevate the spinner to the desired temperature. For example, in a combustion reaction of air and natural gas, as used in the prior art, the maximum burn temperature of the air and natural gas mixture is about 3,600° F. Combustion of the pure oxygen and natural gas combustion fuel mixture of the present invention raises the burn temperature to about 9,145° F. Because the pure oxygen and natural gas combustion fuel mixture of the present invention burns so much hotter than prior art fuel mixtures, about 50% to about 75% less natural gas is required in the combustion fuel mixture to elevate the spinner to the temperature desired to fiberize glass. Also, the spinner temperature may be elevated to the desired temperature faster with the present combustion fuel mixture. By way of further example, in prior art fiberizing processes, approximately 20 lb/min of glass fiber is produced when a spinner is heated with a combustion mixture of air and natural gas in which the fiberizer burners are supplied with about 20 lb/min of natural gas. By using the combustion fuel mixture of the present invention, 20 lb/min of glass fiber may be produced by supplying the fiberizer burners with about 1 to about 5 lb/min of natural gas to heat the fiberizer spinner.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of applicant's general inventive concept.

Having described the invention, I claim:

1. A combustion fuel mixture for a fiberizer, said fiberizer having a spinner, consisting of:
natural gas; and
oxygen mixed with said natural gas to form said combustion fuel mixture to be supplied to said fiberizer, wherein combustion of said combustion fuel mixture heats said spinner.

2. The combustion fuel mixture of claim 1, wherein said combustion fuel mixture has excess oxygen in the range of about −2% to about +5% by volume, wherein the completion of combustion of said combustion fuel mixture varies by the amount of said excess oxygen within said range present in said combustion fuel mixture.

3. The combustion fuel mixture of claim 2, wherein said combustion fuel mixture has about +1.5% excess oxygen by volume.

4. A combustion fuel mixture for a fiberizer having a spinner, comprising:
air;
oxygen added to said air to form oxygen enriched air; and
natural gas added to said oxygen enriched air to form said combustion fuel mixture to be supplied to said fiberizer, wherein combustion of said combustion fuel mixture heats said spinner.

5. The combustion fuel mixture of claim 4, wherein said oxygen enriched air is comprised of about 26% to about 99% of oxygen by volume.

6. The combustion fuel mixture of claim 4, wherein said oxygen enriched air is comprised of about 70% to about 80% oxygen by volume.

7. A process for fiberizing molten glass supplied to a fiberizer having a spinner, said process comprising the steps of:
heating said spinner by combustion of a combustion fuel mixture comprising natural gas and oxygen enriched air, wherein nitrogen comprises no more than about 74% by volume of said oxygen enriched air;
dropping said molten glass into said spinner;
ejecting said molten glass from said spinner to form glass fibers; and
sucking said glass fibers downwardly into a forming room.

8. A process for fiberizing molten glass supplied to a fiberizer having a spinner, said process comprising the steps of:
heating said spinner by combustion of a combustion fuel mixture consisting of oxygen added to natural gas;
dropping said molten glass into said spinner;
ejecting said molten glass from said spinner to form said glass fibers; and
sucking said glass fibers downwardly into a forming room.
